(19) United States
(12) Patent Application Publication
(10) Pub. No.: US 2026/0013539 A1
(43) Pub. Date: Jan. 15, 2026

(54) Pre-Workout Formula with Glycerol Liquid and Integrated Scoop Attachment

(71) Applicant: Jesper Uhre Hammersvik, Førde (NO)

(72) Inventor: Jesper Uhre Hammersvik, Førde (NO)

(21) Appl. No.: 18/769,453

(22) Filed: Jul. 11, 2024

(51) Int. Cl. A23L 33/125; B65D 43/02; G01F 19/00

(52) U.S. Cl. CPC A23L 33/125; B65D 43/0235; G01F 19/002; B65D 2251/02; B65D 2251/20

(57) ABSTRACT

The present invention describes a pre-workout supplement designed for athletes and fitness enthusiasts, incorporating glycerol liquid to improve hydration and stamina during physical exertion. Glycerol, known for its ability to retain fluids and prolong endurance, enhances the efficacy of the formula. The supplement also features a unique packaging innovation: a scoop attached to the interior of the lid. This design ensures easy access and precise dosing while preventing the scoop from being lost within the container. The combination of a scientifically advanced formula with user-centric packaging provides a superior pre-workout experience, promoting optimal hydration and performance in a convenient and hygienic manner. This invention represents a significant improvement in the delivery and effectiveness of pre-workout supplements.

### BACKGROUND

### Field of the Invention

This invention pertains to the field of sports nutrition and dietary supplements, particularly focusing on pre-workout formulations. It involves the integration of glycerol liquid into pre-workout supplements to enhance hydration and performance, along with an innovative packaging solution that includes a scoop attached to the underside of the lid for user convenience and precision.

### Description of the Related Art

The sports nutrition industry has experienced substantial growth over the past few decades, driven by increasing awareness of the importance of diet and supplementation in enhancing athletic performance. Pre-workout supplements, specifically, have become a cornerstone for many athletes and fitness enthusiasts seeking to maximize their training sessions. These supplements typically contain a blend of ingredients designed to boost energy, improve focus, enhance endurance, and support muscle recovery. Traditional formulations often include caffeine, creatine, beta-alanine, and amino acids. However, the quest for improved performance and better user experience continues to drive innovation in this field.

The importance of pre-workout supplements cannot be overstated for serious athletes and fitness enthusiasts. These products are designed to provide a quick and effective energy boost, enhance mental focus, increase endurance, and support muscle function during intense workouts. By improving these key areas, pre-workout supplements can help individuals train harder and longer, leading to better performance and faster results. Moreover, proper hydration and nutrient delivery during workouts are critical for maintaining muscle function and preventing fatigue. Therefore, a well-formulated pre-workout supplement can make a significant difference in an athlete's training regimen.

Several companies have introduced innovative approaches to pre-workout supplementation. For example, some have focused on creating stimulant-free formulas for users sensitive to caffeine. Others have integrated advanced delivery systems such as effervescent tablets and liquid shots for faster absorption. Additionally, many brands have started incorporating natural and organic ingredients to cater to the growing demand for clean-label products. There are also products that emphasize specific benefits, such as enhanced nitric oxide production for better blood flow or adaptogens to help manage stress and improve recovery. These innovations aim to address various user needs and preferences, broadening the appeal and effectiveness of pre-workout supplements.

By looking at prior art, multiple advancements can be seen. For instance, a US patent 2,011,0281808A1 relates to Composition and Method for Increasing Pre Workout Thermogenics. The present invention provides a composition for causing a simultaneous and synergistic increase in central nervous system activity and thermogenesis in a mammal, comprising Yerba Mate as a source of caffeine, hordenine and naringin. The present invention further provides a composition for causing a simultaneous and synergistic increase in central nervous system activity and thermogenesis in a mammal, comprising from 0.0001 g to 0.25 g of caffeine from Yerba Mate leaves, from 0.00001 g to 0.75 g of hordenine from barley and from 0.00001 g to 0.75 g of naringin sourced from grapefruit. The present invention finally provides a method for causing a simultaneous and synergistic increase in central nervous system activity and thermogenesis in an mammal prior to physical exercise, said method comprising providing a composition comprising a source of caffeine, hordenine and naringin and administering the composition to an mammal prior to physical exercise.

A US patent 2,009,0068300A1 relates to Pre- and post-workout formulations processes and supplement products thereby. An improved process for manufacturing, using, and optimizing performance of a mammal using a pre- and post-workout supplement discloses important ingredients, formulations, and dosage protocols. Elite athletes, average consumers, and select groups of those challenged can be benefited by products by the disclosed processes, as evinced by the performance of UFC once and future light-heavyweight Champion of the World, Chuck “The Iceman” Liddell at UFC 88 in Atlanta, Ga. on 6 Sep. 2008.

A U.S. Pat. No. 5,817,329A relates to a nutritional supplement for increased muscle size and strength for body builders. The present invention relates to the method and composition for use of diet supplements by athletes and bodybuilders. A first supplement comprising, the amino acid acetyl-L-Carnitine, in conjunction with a series of nutritionally essential branched-chain amino acids, zinc, OKG, taurine, in conjunction with two other independently administered supplements: a fat burning agent and a creatine synthesizer.

Despite these advancements, consumers still face several shortcomings with current pre-workout supplements. One major issue is the inconsistency in dosing, often due to lost or misplaced scoops. This can lead to either under-dosing or over-dosing, both of which can affect performance and safety. Additionally, many pre-workout formulas lack sufficient hydration support, leading to dehydration and its associated negative effects during intense workouts. Some users also report gastrointestinal discomfort from certain ingredients, and the effectiveness of some supplements can vary greatly among individuals. Finally, the clutter of different ingredients can sometimes lead to a lack of focus on key performance areas, diluting the overall effectiveness of the product.

The proposed invention addresses these consumer needs with a pre-workout formula that incorporates glycerol liquid and features a scoop attached under the lid. Glycerol is known for its superior hydration properties, helping to maintain optimal fluid balance and enhance endurance during workouts. The attached scoop design eliminates the common issue of losing the scoop, ensuring consistent and accurate dosing every time. This thoughtful combination not only enhances the functional benefits of the supplement but also significantly improves the user experience. By focusing on hydration, muscle pumps, and convenience, our product sets a new benchmark in the pre-workout supplement category.

This innovative pre-workout formula with glycerol liquid and an attached scoop under the lid fills a critical gap in the market. It directly addresses the issues of hydration and dosing consistency, which are often overlooked in other products. By enhancing hydration, the formula helps prevent muscle cramps and fatigue, allowing users to perform at their best. The attached scoop ensures that users always have the correct dosage, maximizing the effectiveness of each workout session. This dual approach not only meets the immediate needs of athletes and fitness enthusiasts but also sets a new standard for convenience and performance in the pre-workout supplement industry. Through this innovation, a comprehensive solution that enhances overall workout efficiency and user satisfaction is provided.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of a pre-workout formula with Glycerol liquid and integrated scoop attachment.

It is also the objective of the invention to enhance athletic performance through innovative ingredients such as glycerol.

Another object of this invention is to provide a new and improved formula with improved hydration levels during workouts by incorporating glycerol liquid.

It is an object of the invention to boost endurance and stamina with the unique inclusion of glycerol in the pre-workout formula.

It is also the objective of the invention to simplify the pre-workout preparation by providing a scoop attached under the lid.

It is moreover the objective of the invention to ensure precise dosing with an integrated scoop, minimizing measurement errors.

It is also the objective of invention to provide convenience and portability, making it easier for users to take their pre-workout supplement on-the-go.

It is another object of the invention to prevent contamination and spillage, as the scoop is stored separately under the lid.

Yet another object of the present invention to support muscle pump and blood flow enhancement through glycerol's properties.

It is a further aspect of the present invention to create a novel pre-workout experience that stands out in a crowded market.

Thus, it is the objective to provide an all-in-one solution that is both practical and effective for fitness enthusiasts. Other aspects, advantages, and novel features of the present invention will become apparent from the detailed description of the invention when considered in conjunction with the accompanying drawings.

This Summary is provided merely for the purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates the top view of the proposed assembly, as per an embodiment of the present disclosure.

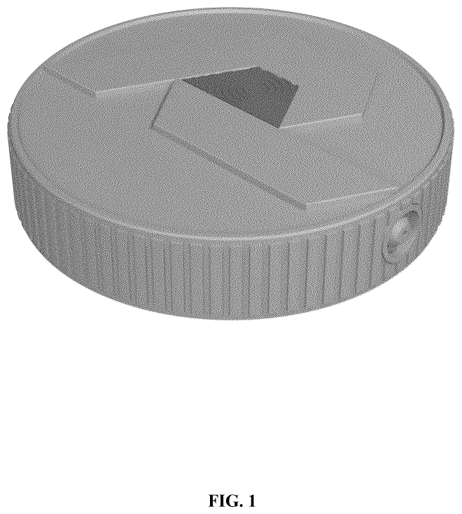

FIG. 2 illustrates the bottom view of the proposed assembly, as per an embodiment of the present disclosure.

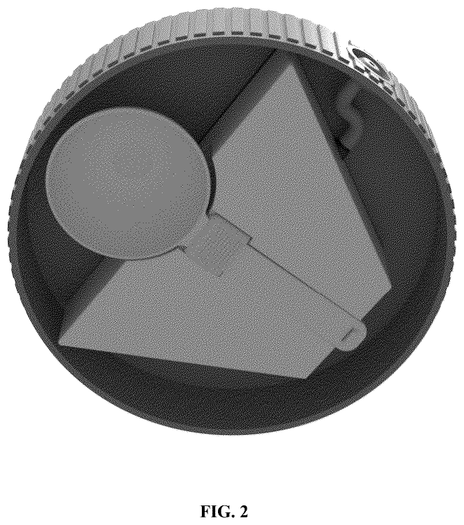

FIG. 3 illustrates the exploded view of cap, as per an embodiment of the present disclosure.

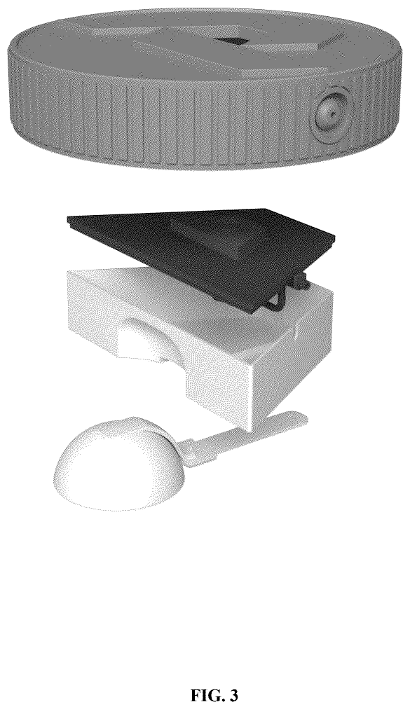

FIG. 4 illustrates the scoop, as per an embodiment of the present disclosure.

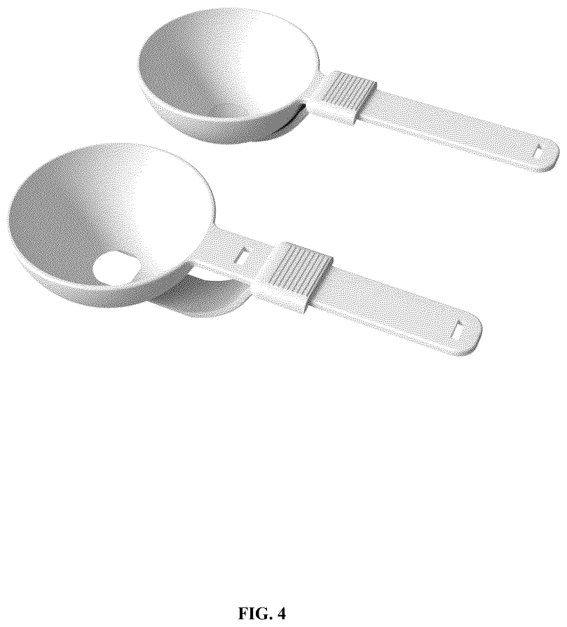

FIG. 5 illustrates another structural view, as per an embodiment of the present disclosure.

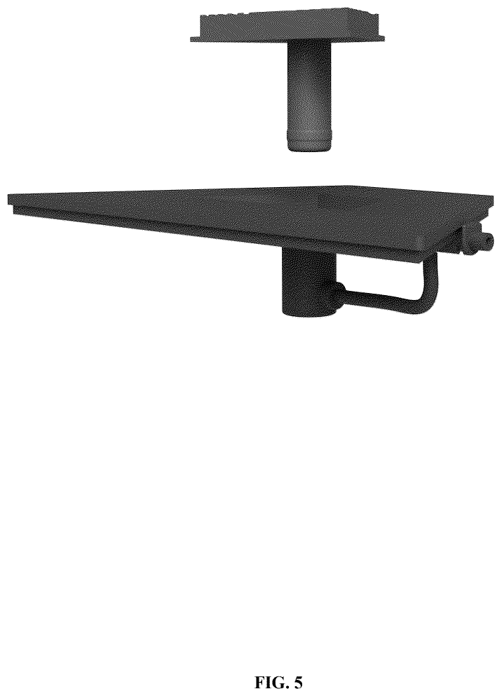

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The realm of sports nutrition has evolved significantly, driven by the continuous quest to optimize athletic performance and workout efficiency. Among the latest innovations is a cutting-edge pre-workout formula that incorporates glycerol liquid, a powerful ingredient known for its superior hydration properties. This formula not only aims to boost energy and endurance but also tackles common challenges such as hydration and muscle fatigue. Enhancing its user-friendliness, the product features a uniquely designed scoop attached under the lid, ensuring precise and convenient dosing. Together, these features represent a groundbreaking advancement in pre-workout supplementation, catering to the multifaceted needs of athletes and fitness enthusiasts.

As per its preferred embodiments, the proposed innovative pre-workout formula is the inclusion of glycerol liquid, a naturally occurring compound renowned for its hyper-hydrating capabilities. Glycerol enhances the body's ability to retain fluids, which is critical during strenuous physical activities. By increasing intracellular water volume, glycerol helps maintain optimal hydration levels, significantly reducing the risk of dehydration, muscle cramps, and performance decline. This ensures that athletes begin their workouts in a state of peak hydration, allowing for sustained endurance and improved overall performance. The hyper-hydration effect of glycerol is particularly advantageous in prolonging physical exertion, thus enabling athletes to train harder and longer.

As per its further embodiments, the formula's glycerol content also plays a pivotal role in enhancing muscle pumps and vascularity. Glycerol's osmotic properties draw water into muscle cells, increasing their volume and giving a more pronounced muscle pump during exercise. This not only improves the aesthetic aspect of muscle definition but also facilitates better nutrient delivery to muscle tissues, thereby supporting faster recovery and muscle growth. The heightened vascularity and muscle fullness can serve as a strong motivational factor for athletes, encouraging them to push their limits and achieve superior results in their training sessions.

As per its further embodiments, adding to the product's innovation is the inclusion of a scoop attached under the lid. This design addresses a common inconvenience faced by users of powdered supplements: losing or misplacing the scoop. By attaching the scoop securely to the underside of the lid, it remains consistently accessible and maintains the cleanliness and integrity of the powder. This thoughtful design ensures accurate dosing every time, eliminating the variability and inconsistency that can occur with improvised measures. The convenience of having the scoop readily available enhances the overall user experience, making the preparation of the pre-workout supplement quick and hassle-free.

As per its further embodiments, beyond glycerol, the pre-workout formula is enriched with a synergistic blend of other performance-enhancing ingredients. Typically, such supplements include amino acids like beta-alanine and branched-chain amino acids (BCAAs), caffeine, and other compounds known for boosting athletic performance. Amino acids play a crucial role in muscle recovery and reducing exercise-induced fatigue, while caffeine provides a quick and effective energy boost, improving focus and mental alertness. Combined with glycerol's hydration and muscle pump benefits, these ingredients create a comprehensive pre-workout supplement designed to maximize performance, endurance, and overall workout efficiency.

As per its further embodiments, the pre-workout formula with glycerol liquid and an attached scoop under the lid marks a significant milestone in sports nutrition. Glycerol's exceptional hydration and muscle volumizing properties, coupled with the practical design of the attached scoop, set this product apart in the crowded market of pre-workout supplements. By addressing both the functional and practical needs of athletes and fitness enthusiasts, this innovative formula enhances performance, convenience, and user satisfaction. As the fitness industry continues to evolve, such advancements are likely to set new standards for product development, ensuring that athletes can achieve their peak potential with ease and efficiency.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A pre-workout supplement formulation comprising:
glycerol liquid as an active ingredient to enhance hydration and endurance during physical activity;
a container configured to store the pre-workout supplement; and,
a scoop attached to the underside of the container lid for precise and convenient measurement.
The pre-workout supplement formulation of claim 1, wherein the glycerol liquid concentration ranges from 1% to 10% by weight of the total formulation.
The pre-workout supplement formulation of claim 1, further comprising additional ingredients selected from the group consisting of caffeine, beta-alanine, citrulline, creatine, and electrolytes.
The pre-workout supplement formulation of claim 1, wherein the scoop has a predefined volume to ensure an accurate serving size of the pre-workout formula.
The pre-workout supplement formulation of claim 1, wherein the scoop is made of a material selected from the group consisting of plastic, biodegradable polymers, and metal.
The pre-workout supplement formulation of claim 1, wherein the lid comprises a snap-fit mechanism to securely hold the scoop in place under the lid.

2. A pre-workout supplement packaging system comprising:
a container filled with a pre-workout formula containing glycerol liquid, a lid securing the container, and
a scoop integrally attached to the underside of the lid for easy accessibility and measurement accuracy.
The pre-workout supplement packaging system of claim 2, wherein the container is made of a material selected from the group consisting of plastic, glass, and metal.
The pre-workout supplement packaging system of claim 2, wherein the lid comprises a sealing mechanism to ensure the container remains airtight, preserving the quality of the pre-workout formula.
The pre-workout supplement packaging system of claim 2, wherein the scoop is detachably attached to the lid for easy removal and replacement.
The pre-workout supplement packaging system of claim 2, wherein the lid and scoop are designed to be tamper-evident, providing an indication if the container has been previously opened.
The pre-workout supplement packaging system of claim 2, wherein the lid further includes an ergonomic grip to facilitate opening and closing the container.
